(19) United States
(12) Patent Application Publication
(10) Pub. No.: US 2004/0112523 A1
(43) Pub. Date: Jun. 17, 2004

(54) Three dimensional printing from two dimensional printing devices

(76) Inventors: Elden Wendell Crom, Oro Valley, AZ (US); Stacey Lynn Crom, Oro Valley, AZ (US)

Correspondence Address: Elden W. Crom, 12463 N. Wayfarer Way, Oro Valley, AZ, 85737, US

(21) Appl. No.: 10/683,792

(22) Filed: Oct. 10, 2003

Related U.S. Application Data
(60) Provisional application No. 60/418,297, filed on Oct. 15, 2002.

(51) Int. Cl. B32B 31/00

(52) U.S. Cl. 156/290; 156/275.1; 156/275.3

(57) ABSTRACT

A method of rapid prototyping a physical three-dimensional Product that can be preformed on readily available commercial 2D printing devices and paper handling equipment is presented. The method consists of using a 2D printing process to obtain a stack of sheets, each sheet printed with successive cross sectional areas of the desired product with ink (Hardener) that causes the sheet to become resistant to subsequent weakening and removal after the creation of the Brick. The Brick, containing both the positive (printed areas) and negative (unprinted areas), is then subjected to an agent(s) that weakens and removes the unwanted negative regions leaving only the desired Product.

### 2.0 CROSS-REFERENCE TO RELATED APPLICATIONS

This application is based upon provisional application for patent number 60/418,297 filed on Oct. 15, 2002.

### 3.0 STATEMENT REGARDING FEDERALLY SPONSORED RESEARCH OR DEVELOPMENT

Not Applicable

### 4.0 SEQUENCE LISTING OR PROGRAM

Not Applicable

### 5.0 BACKGROUND OF THE INVENTION

5.1 With the advent of modem computers and sophisticated CAD (Computer Aided Design) systems, many methods of CAM (Computer Automated Manufacturing) have been developed to provide both useable products and visual aids. Holding a physical model in one's hands often assists in finding defects and inspires design improvements. For architectural purposes, seeing the resultant building or landscape can go a long way toward bringing the project to life. For the movie and theater industries this methodology offers a new option for the creation of sets and props. For dentistry, creating a mold of what shape the teeth or jaw will become is crucial for successful treatment. For surgery, having a concrete, viewable model to work with can provide crucial guidance to the appropriate techniques to use for a given operation. On the lighter side, if 3D printing where cheap in both initial cost and the cost of expendables, many uses will appear for the home and office that are not currently considered. Perhaps unique customizable physical devices, buttons, gifts, toys, games, tools, copies of physical objects, etc could be sold over the internet and fabricated by the purchaser on an ordinary printer.

5.2 Until now the prior art has provided methods for accomplishing the similar effects, but required specialized equipment that had no other purpose than to create the models or parts. Having specialized, unusual equipment, inherently makes that equipment difficult to obtain, and costly to own and maintain. The present invention allows the production of modest quality models, parts, etc. on commonly available, inexpensive computer printers, with a minimum of inexpensive equipment unique to the rendering of the three dimensional product.

5.3 Prior methods used to produce 3D objects include:

1) Milling—removal of pieces of a solid, via grinding or cutting, leaving the desired part intact.

2) Gluing multiple layers of precut substrate together.

3) Ejection of droplets of material that hardens (solidifies) to form the desired part. 5,059,266; 5,126,529; 5,121,329 with positive and negative image before hardening 5,136,515; 5,140,937, powder and bonding agent 5,204,055

4) Repeated deposition or deepening submersion of the unfinished product on or into a powder or fluid of uncured substance just prior to hardening, via stereo lithography or laser sintering—5,134,569 Laser hardening of liquid epoxy or sintering of a powder solid. 4,863,538 (For an eloquent, but not as succinct, description of 4 please refer to the Background of 6,416,850.)

### 6.0 BRIEF SUMMARY OF THE INVENTION

6.1 Definitions (for the purposes of this application):

Product—a physical three-dimensional object of arbitrary shape, usually, but not limited to, originating from a computer model.

Substrate—a solid material or materials that possess the ability to be dissolved, weakened or otherwise removed by a Solvent but can be treated with a Hardener and/or Resin Carrier to make the portions of the Substrate mostly unaffected by the Solvent, in practice this will usually be a sheet of material with physical properties and dimensions substantially similar to paper, such as a water-soluble paper impregnated with resin.

Brick—a block of material composed of sheets of Substrate where each successive layer has been prepared such that selective areas will harden or not in a pattern corresponding to successive cross-sectional areas of the desired Product. The Brick contains both the positive 3D image of the Product, in the form of the printed Hardener, and negative of the image, in the form of the unhardened areas.

Hardener—a substance that will, under certain conditions, cause the Substrate to become relatively impervious to the Solvent.

Solvent—substance (liquid or gaseous) which has the ability to dissolve, weaken or otherwise allow untreated sections of the Substrate to be removed, but does not have ability to help remove significant parts of the Substrate that have been treated with Hardener. (Note that this definition is looser then that used in the field of chemistry.)

6.2 Using the methods of the present invention, successive cross-sectional areas of the desired Product will be printed using the Hardener as the ink on successive layers of the Substrate. Said layers of the Substrate will be stacked one on top of the other to form a Brick. Said Brick will be subjected to conditions that will cause said Hardener to take effect. Said conditions maybe one or more of aging, heating, electromagnet radiation, etc. Said Hardener of each layer, having been in contact with both the present layer and the subsequent layer will fuse said present layer to a portion of said subsequent layer. In the case where both cross-sectional areas have the Hardener placed on them in adjacent regions, the hardened regions of both will fuse. In the case where the present layer has been treated with said Hardener the corresponding area of the adjacent layer has not, preferably only a small portion of the said adjacent layer will harden. This pattern of hardened and unhardened regions is formed in the Brick. To improve the quality and strength of the Product, the Brick may be compressed in the direction of the layering; thereby increasing the transfer of a portion of the Hardener to the unprinted side of the Substrate thus increasing the bonding strength between the layers. A possible extension of this process would be to print both sides of the Substrate with the Hardener possibly combined with an additional binding agent. The Brick is then exposed to the Solvent to weaken and allow the unhardened portions of the Brick to be removed. What remains is the desired Product.

6.3 The primary intention of the present invention is to produce small volumes of arbitrarily shaped objects using readily available, inexpensive equipment. Thus reducing the cost of producing prototypes of and small production runs of the desired physical three-dimensional Product. While not exclusive to CAD/CAM, the primary benefit will be felt in those areas. In the future, a system may be generated to capture sufficient three-dimensional image information (3D images) such that instead of just taking a picture of an event, a 3D model could be produced as commonly as a photograph. After becoming sufficiently inexpensive, this ability could have impact on fields as varied as crime scene investigation, movie making, and home photo album making. A logical extension of this low volume use would be to use newspaper style printers to expand the method's utility to higher production levels.

6.4 The technique presented herein overcomes the limitations of 5.3.2 and 5.3.3 by leaving both the positive and negative aspects of the object intact until the Product has hardened to become a contiguous solid. It also eliminates the specialized, complex, expensive equipment required for all four processes mentioned in 5.3 by utilizing cheap and simple 2D printing processes.

6.5 Another advantage of the method presented here is that the majority of the hardening occurs after the product is incased in the Brick, thereby preventing or reducing curling and other affects of uneven curing.

6.6 While significantly similar in the choice of filler, adhesive, and hardening agent and hardening agent delivery system as found in U.S. Pat. No. 6,416,850, the article presented herein presents the unique and novel approach for the delivery of the filler and adhesive and the order of processing. The filler combined with the adhesive and hardening agent of the present article is combined to form a substantially solid Substrate quite similar in rigidity and dimensions to common paper which is then stacked to form a solid block consisting of both the positive and negative of the desired three-dimensional product; whereas the prior art deposits the filler and adhesive on top of the partially formed Brick before introducing the hardening agent. The method presented here allows a common 2-D printer and paper handlers to form and possibly even stack the layers into the Brick.

### 7.0 DRAWINGS

Not Applicable

### 8.0 DETAILED DESCRIPTION OF THE INVENTION

8.1 Preferred Embodiment

The simplest implementation of this method is to use an inkjet printer to apply resin-hardener to the areas intended to create the resultant Product to many separate sheets of water-soluble paper. Care must be taken to ensure that the resin will not significantly weaken the water-soluble paper. For the purposes of demonstration, Dissolvo™ D60S paper, Evercoat™ Fiberglass Resin and its hardener, and an HP™ 656cvr or Lexmark™ Z23le were chosen and used. The separate layers are subsequently stacked and other sheets of substrate that have been impregnated with fiberglass resin are inserted between each printed sheet. The resultant mass of paper, resin, and hardened resin, the Brick, contains the desired 3D Product. Said Brick is then submersed in water and then agitated by brushing, rubbing, and a mild pressure spray of solvent to erode the negative portions of the Brick, leaving behind the hardened resin in the shape of the desired Product.

8.2 In conclusion, the method presented provides an inexpensive alternative to the existing prior art's methodologies used to produce three dimensional objects of arbitrary shape by utilizing widely available, inexpensive two dimensional printers. This newly formed price range for this type of technology will revolutionize the creativity and capacity of small entities' design capability and other low volume production applications. This methodology of converting 2D printers to 3D printers is broadly applicable to most 2D printing processes.

9.1 I claim the following:

1) A method for creating a product by stacking thin layers of substantially uniform lamenting substrate (similar in nature to sheets of paper), after processing such that some portions of the material (the negative) will dissolve or weaken sufficiently to be easily removed and other portions, those treated with a chemical hardener or hardener precursor, will remain to adhere to other treated layers of substrate immediately above and below the current layer (the positive), if they exist, after subsequently exposing the resultant brick to the appropriate solvent and/or agitation to remove the untreated portions of the brick results in the product.

2) The claims of 1, with an additional step of treating the brick with heat, penetrating electromagnetic radiation, compression or other means of speeding or initiating the hardening process of the treated areas.

3) The claims of 1, using an inkjet style printer to deliver a chemical hardener to a sheet of the material to be hardened.

4) The claims of 1, adding pigments to the substrate, independently or with the hardener, to apply color to the finished part.

5) The claims of 1, with the numbers of layers being few enough to appear similar in nature to a single laminated sheet of paper.

6) The claims of 1, where the substrate is impregnated with a liquid resin.

7) The claims of 6, where the substrate is coated with a substance to facilitate reliability of the paper handling equipment.

8) The claims of 6, where the resin is substantially similar to Evercoat™ Fiberglass Resin or Bondo™ All-Porpose Fiberglass Resin.

9) The claims of 6, where the incomplete substrate is substantially similar to Dissolvo™ D60S.

10) The claims of 1, where the hardener is encapsulated in micro-spheres that are made permeable or broken by heat, cold, pressure, penetrating electromagnetic radiation (probably microwave) after the sheets of substrate have been assembled.

11) The claims of 1, where the 2D printing device that delivers a powder hardener such as a laser printer.

12) The claims of 11, where the powder consists of micro-spheres containing a liquid hardener.

13) The claims of 1, with sheets of resin impregnated substrate inserted between each hardener printed sheet.

14) The claims of 1, where each sheet of substrate is adhered into a window of a carrier sheet to facilitate effectiveness of the paper handling mechanism.

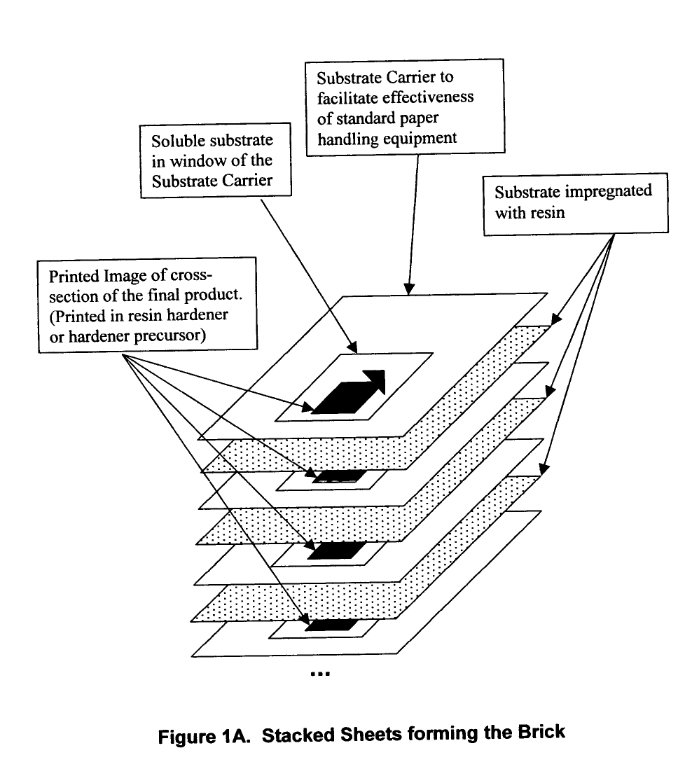

15) The claims of 13, where each sheet of substrate is adhered into a window of a carrier sheet to facilitate effectiveness of the paper handling mechanism, similar to that presented in FIG. 1A.
